(19) United States
(12) Patent Application Publication
(10) Pub. No.: US 2007/0168082 A1
(43) Pub. Date: Jul. 19, 2007

(54) Task-based robot control system for multi-tasking

(75) Inventors: Bongjoon Kim, Seoul (KR); Jungmin Oh, Busan (KR); Poogyeon Park, Pohang-si (KR)

Correspondence Address: HARNESS, DICKEY & PIERCE, P.L.C., P.O. BOX 828, BLOOMFIELD HILLS, MI, 48303, US

(73) Assignee: Robostar Co., Ltd., Kyonggi-do (KR)

(21) Appl. No.: 11/478,487

(22) Filed: Jun. 29, 2006

(30) Foreign Application Priority Data
Jan. 17, 2006 (KR) 2006-4771

(51) Int. Cl. G06F 19/00

(52) U.S. Cl. 700/245

(57) ABSTRACT

The present invention relates to a PC-based robot control system, which is a new type of a robot control machine. The present invention has aimed at a task-based control machine configuration not a centralized control configuration so that a multi-tasking function is possible through a distributed control system. An embodiment of the present invention provides a task-based robot control system, including robot system interface means that receives a control command for controlling a robot; system kernel means that controls the creation and distinction of one or more software-based virtual robot control machines of virtual robot controller means, which will be described later, in a software way and controls the synchronization between the virtual robot control machines, based on the control command received from the robot system interface means; the virtual robot controller means having one or more software-based virtual robot control machines whose creation and distinction are controlled under the control of the system kernel means, wherein a generated virtual robot control machine processes a robot control execution sentence input through the robot system interface means; and hardware means that actually drives the robot according to a control signal generated by the processing of the execution sentence by the virtual robot control machine.

### BACKGROUND OF THE INVENTION

1. Field of the Invention

The present invention relates to a system of a PC-based robot control machine. More particularly, the present invention relates to a task-based robot control system for multi-tasking, in which an existing hardware-based robot control machine type can be applied as a new software-based robot control machine and software-based multi-tasking is enabled, whereby it is significantly advantageous for a user to construct work environment as compared with an existing PC-based control machine, and the productivity can be improved and the production line design cost can be saved through the improvements of user convenience.

2. Background of the Related Art

A PC-based control machine refers to a software-based control machine in which a hardware or firmware-based control machine implemented by existing DSP or ASIC is programmed using software so that it can be used in a PC. A main reason why the application of a PC system to the robot control machine is required is that as the complexity of the production line is increased, it is necessary for a robot control machine to perform several tasks at the same time while driving the robot.

The robot control machine may be classified into a part (an upper control machine) that processes a program with respect to the motion of the robot and a part (a lower control machine) that controls a machine apparatus. The upper control machine refers to a task program processing part that should be performed by the robot and performs communication with the robot work programming interface, etc. The lower control machine refers to a trajectory plan of the robot and a servo-controlled part and is directly related to the accuracy of the motion of the robot through real-time control.

The existing PC-based control machine is concentrated on the development of a lower control system since it has a dedicated board-based control machine type. This is because there is no need for an additional apparatus for implementing the multi-tasking function since one control machine can control a number of robots in the PC-based control machine.

From this point of view, the upper control machine is responsible for only exchanging information between the user and the control machine. The upper control machine has a Man Machine Interface (MMI)-based centralized control machine configuration, and the lower control machine has a dedicated type.

FIGS. 1a and 1b illustrate the configuration of an existing hardware-based robot control machine.

In an initial hardware-based control system, a control machine corresponding to a subject work robot performs a task on a one-to-one basis as shown in FIG. 1a. In other words, FIG. 1a corresponds to a hardware-based control machine type 1. In this type, one micro controller 1 controls one robot 2. It was found that such configuration is not suitable for a modern production line structure having a multi-kind and small-quantity production scheme. TO overcome the shortcoming, the system has changed to a plural control system as shown in FIG. 1b.

FIG. 1b corresponds to a hardware-based control machine type 2. This type includes one main control machine 2, a sub control machine1 2a having a number corresponding to that of a lower control machine, and a sub control machine2 2b. The sub control machine1 2a controls a robot1 3a, and the sub control machine2 2b controls a robot2 3b.

The construction as shown in FIG. 1b is a construction in which hardware is added to the basic 1:1 matching construction of FIG. 1a. Therefore, the construction can perform multi-tasking in terms of function, but is disadvantageous in that the construction of hardware becomes complicated as a task to be performed is increased.

FIG. 2a shows the related art robot control system. The robot control system of FIG. 2 corresponds to a previous step of a software-based control system according to an embodiment of the present invention. FIG. 2a shows a construction which was developed from the construction of the hardware-based control machine type2 in FIG. 1b by one step.

In the hardware-based control machine type3 of FIG. 2a, a simplified Operation System (OS) 4 that may be used in a specific control machine performs multi-tasking unlike the construction having a plurality of hardware having the hardware-based control machine type 2 of FIG. 1b. This is a significantly advanced construction from the construction in which the multi-tasking function is implemented using only hardware. However, the hardware-based control machine type3 of FIG. 2a was developed to be dependent on a specific micro controller 4a and provides only a limited function regarding the control of a robot1 5a and a robot2 5b.

FIG. 2b shows the construction of a robot control machine of a robot control system employing a PC in the related art. The robot control machine of FIG. 2b is a robot control machine employing the latest PC. The robot control machine of FIG. 2b includes an MMI 6, a task scheduler (task priority setting) 7, a lower control machine 8, a sub hardware1 8a and a sub hardware2 8b.

The lower control machine 8 is an actual device driver level having dedicated software for controlling hardware. The MMI 6 of the upper control machine is an application program used to configure tasks by a user. The scheduler 7 is responsible for scheduling tasks, which will be performed by the control machine, according to the priority. It can be seen that in such a construction, the task scheduler 7 decides the priorities of all tasks. This configuration is referred to as the centralized control architecture. In order for the scheduler 7 to schedule tasks according to the priority, a worker must know all situations in constructing work environment.

The centralized control architecture is executed according to a task procedure in which all situations are predicted in accordance with a procedure-oriented method. In the procedure-oriented method, tasks are performed according to a predetermined order. Therefore, if the complexity of a task is increased, a user may feel difficult in constructing the task. This characteristic is causes since the control machine is designed on the basis of the lower control machine 8. This is in breach of the modularized concept of the PC-based control machine.

Furthermore, as a gap in the hardware development between manufacturers reduces, the performance is decided depending on the software configuration. In addition, as a real-time OS is developed in a hardware access method for guaranteeing the real-time property is developed, real-time control of hardware is made possible through software.

Due to averaged hardware developments and a developed real-time OS, prominence is given to the developments of an upper control machine as a method for enhancing the efficiency of the PC-based control machine.

In the above-mentioned related art centralized control type PC-based control machine, however, a user has to manage items of all tasks according to the priority. It is thus difficult to make the best use of the properties of the PC-based control machine with user convenience being added thereto on the basis of various software functions.

### SUMMARY OF THE INVENTION

Accordingly, the present invention has been made in view of the above problems occurring in the prior art, and an embodiment of present invention relates to a robot control system through a task-based distributed control method not a centralized control method.

In an embodiment of the present invention, the term “task” refers to a job file necessary to drive the robot. The term “task-based” refers to a task on which the robot will operate. The robot is the subject to execute the task in the robot control system. The task can be accessed as a concept to perform the task by a single robot.

In addition, in the task-based control system, since each task operates independently, it does not affect other tasks although an exceptional situation happens during the task. If this method is applied to a business robot control machine, the complexity occurring in the existing robot system design process can be reduced and the degree of understanding on the task by a user can be increased. It is thus possible to improve the productivity and save the cost for constructing development environment.

In accordance with the present invention, an existing hardware-based robot control machine type can be applied as a new software-based robot control machine and software-based multi-tasking is enabled. Accordingly, a user can construct work environment efficiently in comparison with an existing PC-based control machine.

A distributed control type control machine according to the present invention can construct an independent robot system according to a job file of a minimal unit, which is desired by a user.

The present invention provides a control system through a virtual robot control machine as a task-based robot control machine. The control system is constructed to have a parallel configuration not a vertical hierarchical configuration. In the control machine configuration, the priority needs not to be set on a task basis and a user needs not to perform arbitrary setting unlike the existing PC-based control machine. Therefore, lots of convenience can be provided to a user who constructs work environment. This characteristic is related to an increase in the productivity.

A task-based robot control system for multi-tasking according to an embodiment of the present invention includes:

robot system interface means that receives a control command for controlling a robot;

system kernel means that controls the creation and distinction of one or more software-based virtual robot control machines of virtual robot controller means, which will be described later, in a software way and controls the synchronization between the virtual robot control machines, based on the control command received from the robot system interface means;

the virtual robot controller means having one or more software-based virtual robot control machines whose creation and distinction are controlled under the control of the system kernel means, wherein a generated virtual robot control machine processes a robot control execution sentence input through the robot system interface means; and

hardware means that actually drives the robot according to a control signal generated by the processing of the execution sentence by the virtual robot control machine.

### BRIEF DESCRIPTION OF THE DRAWINGS

Further objects and advantages of the invention can be more fully understood from the following detailed description taken in conjunction with the accompanying drawings in which:

FIGS. 1a and 1b illustrate the configuration of an existing hardware-based robot control machine;

FIGS. 2a and 2b illustrate the configuration of an existing hardware-based robot control machine and a PC-based robot control machine;

FIG. 3 is a conceptual diagram of a task-based distributed control type robot control machine according to an embodiment of the present invention;

FIG. 4 shows the configuration of a software-based robot control machine according to an embodiment of the present invention;

FIG. 5 shows a detailed configuration of the software-based robot control machine shown in FIG. 4;

FIG. 6 is a flowchart showing the operation of a virtual robot control machine scheduler for illustrating multi-tasking within a virtual robot control machine according to an embodiment of the present invention;

FIG. 7 shows a detailed construction of a storage space for storing a task that should be changed to standby mode and a task that should be performed in FIG. 6;

FIG. 8 is a flowchart illustrating the transfer flow of instructions on the basis of each communication module while the virtual robot control machine is driven; and

FIG. 9 is a classified flowchart of a communication-related module in FIG. 8.

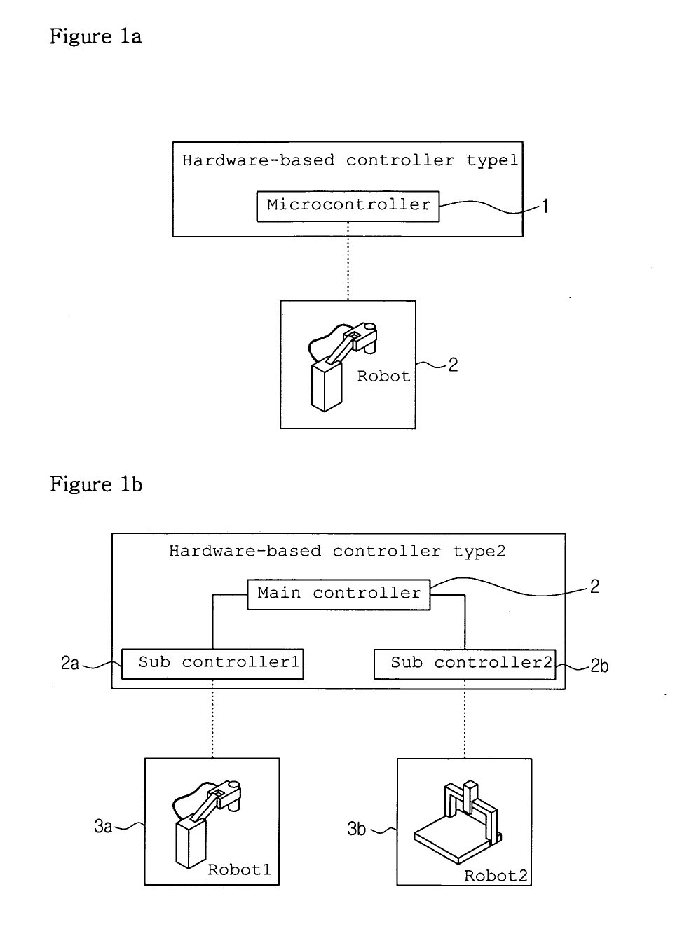

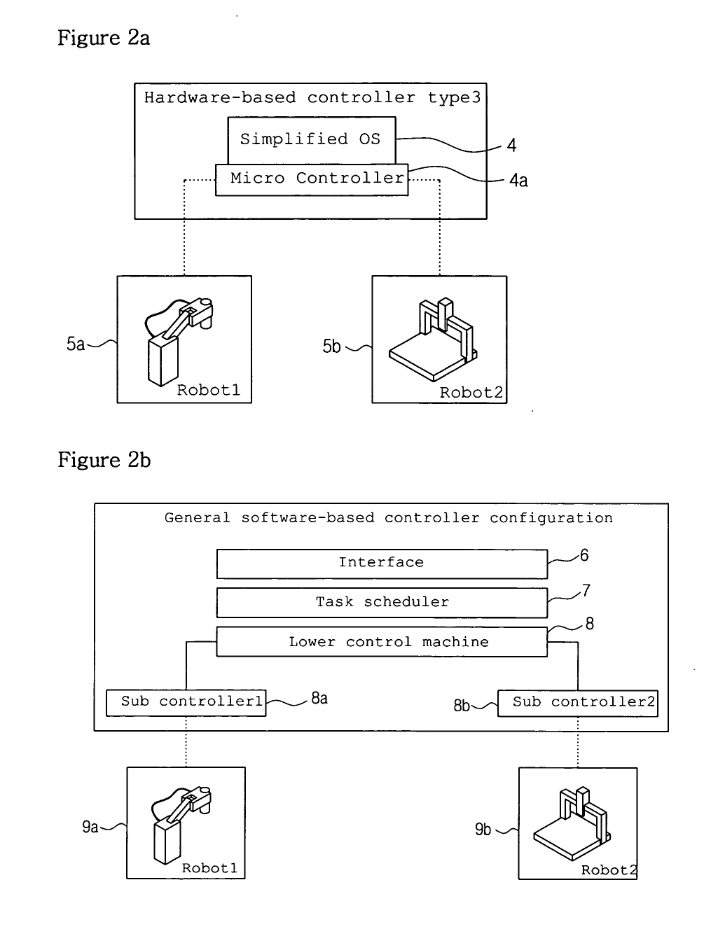

### DETAILED DESCRIPTION OF THE PREFERRED EMBODIMENT

The present invention will now be described in detail in connection with embodiments with reference to the accompanying drawings.

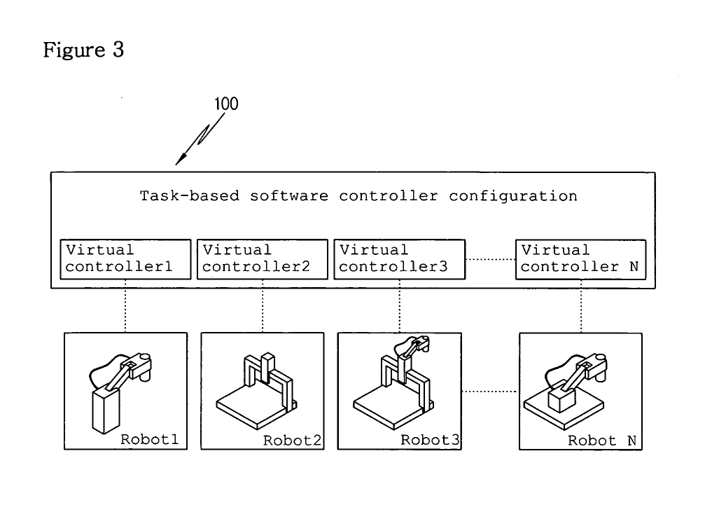

FIG. 3 is a conceptual view of a task-based robot control machine according to an embodiment of the present invention.

A plurality of virtual controllers 1-N are arranged in parallel in a task-based software controller 100.

The virtual controllers 1-N are constructed to control corresponding robots 1 to N, respectively. The controller 100 refers to a robot control system including a software-based virtual robot control machine to be described later.

As shown in FIG. 3, the controller of the present invention has a horizontal and parallel structure not a vertical structure.

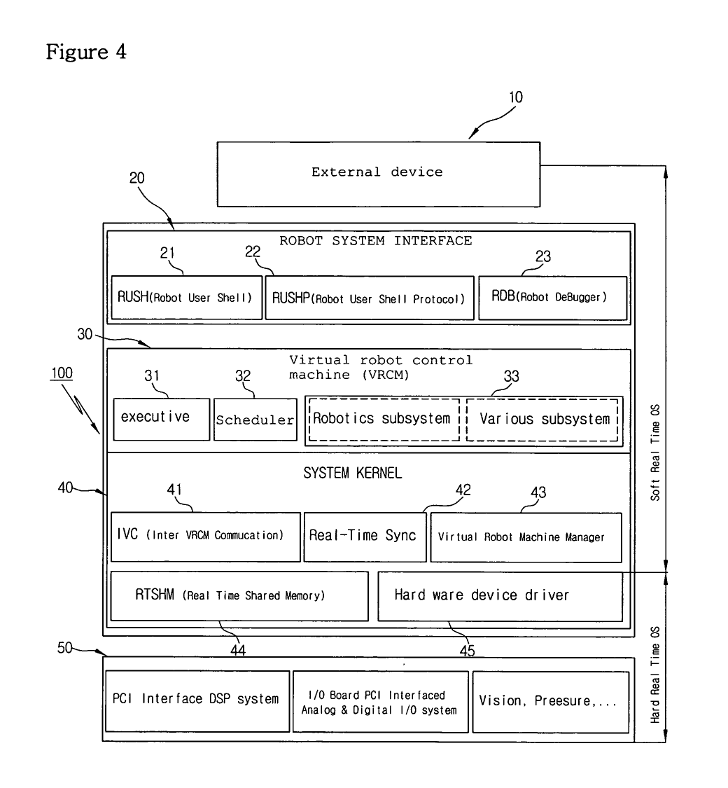

FIG. 4 is a block diagram showing the construction of a robot control system according to an embodiment of the present invention.

The robot control system includes:

an external apparatus 10 including a High Level Robot Program Language (HRPL);

a robot system interface unit 20 that receives a control command for controlling a robot from the HRPL of the external apparatus 10;

a system kernel 40 that controls the creation and distinction of one or more software-based virtual robot control machines within a virtual robot control machine unit 30 in a software way and also controls a synchronization task for multi-tasking control between the virtual robot control machines, based on the control command received from the robot system interface unit 20;

the virtual robot control machine unit 30 having one or more software-based virtual robot control machines whose creation and distinction are controlled in a software way under the control of the system kernel 40, wherein a created software-based virtual robot control machine processes an execution sentence input through the robot system interface unit; and

a hardware unit 50 that actually drives the robot according to a control signal generated by the processing of the execution sentence by the virtual robot control machine.

In the virtual robot control machine unit 30, the creation and distinction of the software-based virtual robot control machines are controlled and a created software-based virtual robot control machine processes a robot control execution sentence.

The system kernel is a module shared between the control machines, for controlling the creation and distinction of the software-based virtual robot control machines of the virtual robot control machine unit and implementing a multi-axis control system through a synchronization task between the software-based virtual robot control machines.

The hardware unit 50 includes a Peripheral Component Interconnect (PCI) interface DSP system, an I/O board, a sensor board, and so on, and actually drives the robot.

The robot system interface level 20 includes a communication module (RUSH: Robot User Shell) 21 that provides connection with an external module of the software-based robot controller according to the present invention, a Robot User Shell Protocol (RUSHP) 22 (i.e., a communication protocol to be used in the communication module (RUSH) 21), for providing a user with the same kind of a protocol regardless of communication means, and a robot debugger (RDB) 23 for performing a debugging task before a user performs an infinite-repetitive task of the robot system.

The virtual robot control machine unit 30 includes an internal Virtual Robot Control Machine (VRCM) execution module 31 for executing a job file written using a robot language, a scheduler 32 for processing a multi-tasking within the virtual robot control machine, and a trajectory generation module (i.e., a robot-dependent module) 33 for creating a trajectory along which the robot will operate.

The system kernel 40 includes an Inter VRCM Communication (IVC) module 41 (i.e., a message transfer module for internal communication between the software-based virtual robot control machines, for managing a synchronization task between robots, a system synchronization module 42 that synchronizes an operating time between an OS for a general user and a real-time OS, a virtual robot control machine management module 43 for managing software-based virtual robot control machines created in plural numbers, a shared module 44 that stores the whole data of the software-based robot controller, and a hardware device drive module 45 that performs communication between the software-based virtual robot control machines and external hardware.

In the robot control system constructed above according to an embodiment of the present invention, if a user specifies a task robot and writes and inputs a robot execution sentence through the external apparatus 10, the robot execution sentence is complied according to the HRPL and is then input to the communication module 21. At this time, the robot user shell protocol 22 supports a protocol such that the user can input the robot execution sentence using the same command system regardless of a communication method (for example, RS232, RS485, or the like) between the external apparatus 10 and the communication module 21.

If a robot control command and the robot execution sentence are input, the virtual robot control machine management module 43 of the system kernel 40 generates a software-based virtual robot control machine within the virtual robot control machine unit 30.

The generated virtual robot control machine controls the execution module 31 to execute the execution sentence, which has been written and input by the user, and to generate a robot control signal. The generated robot control signal is transferred to the hardware unit 50 in order to control the robot.

As a result, in an embodiment of the present invention, when the number of robots to be controlled is plural, a plurality of virtual robot control machines are created within one controller 100 so that the respective virtual robot control machines control corresponding robots, respectively.

The present embodiment of the present invention proposes a real-time OS-based distributed control type control machine configuration in order to implement multi-tasking. In the existing PC-based control machine, the robot control machine is divided into the upper control machine and the lower control machine. In the present embodiment, however, the robot control machine is divided into a hard real-time control machine and a soft real-time control machine.

The soft real-time control machine manages the entire system other than the connection portion that actually drives the robot. The soft real-time control machine performs tasks, such as the management of job files desired by a user, the management of robot parameters and a state monitoring task of a robot that now operates.

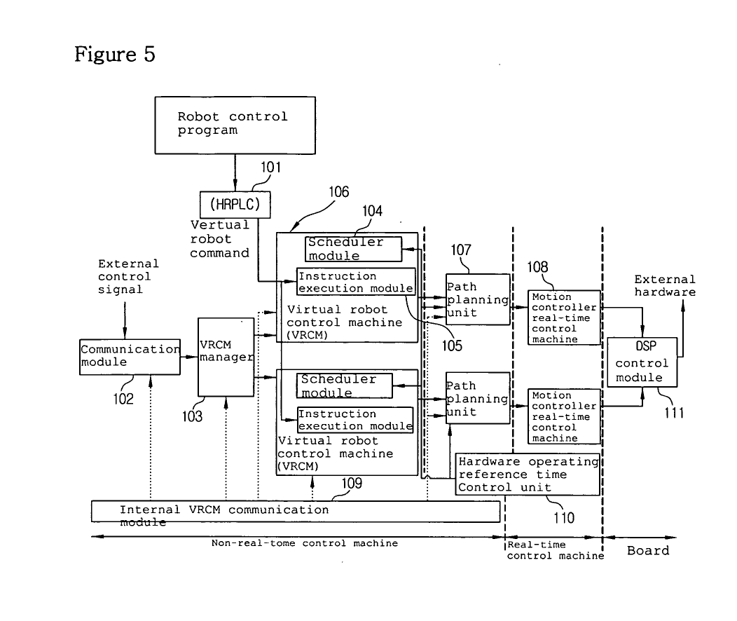

FIG. 5 shows a simplified construction of the control machine to be described later. In other words, FIG. 5 shows a detailed configuration of the software-based robot control machine shown in FIG. 4.

As shown in FIG. 5, the software-based robot control machine shown includes an instruction interpreter 101 for driving the robot control machine proposed by the present invention, an integrated protocol communication module 102 for communication with the external module, a virtual robot control machine manager 103 for creating and extinguishing the virtual robot control machines in order to manage the virtual robot control machine (VRCM), a scheduler 104 for processing multi-tasking generated within the virtual robot control machine, an instruction execution module 105 that executes a robot instruction interpreted by the instruction interpreter 101, a virtual robot control machine 106 that includes the scheduler 104 and the execution module 105 and is generated by the virtual robot control machine manager 103, a trajectory planning unit 107 for creating a trajectory along which the robot will move, a real-time OS module 108 for managing a Peripheral Component Interconnect (PCI) (i.e., a hardware interface for driving the robot), an Inter VRCM Communication (IVC) module 109 that is responsible for internal communication between the robot control machines 106 that are generated from the virtual robot control machine manager 103, and a hardware operating reference time control machine 110 that is a module for driving the real-time OS and serves to transfer a real-time temporal update instruction to the scheduler 104. The virtual robot control machine can be generated in the same number as that of requests by a user, i.e., a number that will be driven.

The soft real-time control machine may be divided into a part that manages a job file written by a user, a communication module that is responsible for communication with the external module and a part that transfers a driving instruction of the robot.

The present embodiment has its purpose to implement a distributed control type robot control machine in which a plurality of robots can be controlled and multi-tasking is enabled. Therefore, the control machine and the robot do not correspond to each other 1:1 or 1:N, but correspond to each other N:N where the number of the control machines is the same as that of the robots to be controlled.

To this end, the present embodiment has introduced a concept called a virtual robot control machine. The virtual robot control machine is a robot control machine of a software form. In this machine, an existing micro controller serves to perform an instruction. The virtual robot control machine has a software shape and can produce as many robot control machines as a number that can be allowed by the specifications of a PC used by a user.

The virtual robot control machine corresponds to a robot to be controlled on a one-to-one basis and performs a task in a separated region. In the present embodiment, the modules of FIG. 5 will be described below on the basis of the virtual robot control machine.

The virtual robot control machine manager (VRCM manager) 103 of FIG. 5 is a module that manages the virtual robot control machine 106 that may exist in the same number as that of tasks. The VRCM manager 103 is responsible for creating and extinguishing the virtual robot control machine 106. If a user requests a robot control machine that will perform TASK1 and TASK2, the VRCM manager 103 generates two virtual control machines 106 and controls them to control the robots.

The present embodiment is related to the robot control system that allows for a multi-tasking function. The term “general multi-tasking” means that a plurality of tasks can be performed at the same time.

If the concept is applied to the robot control machine, a variety of situations generated from work environment can be processed while the robot performs the motion task. The various situations may include an event generated on a robot basis and an event generated between robots that operate. The present embodiment proposes the virtual robot control machine scheduler (VRCM scheduler) 104 of FIG. 5 in order to smoothly process the events.

The present embodiment is based on an independent concept of the virtual robot control machine 106 so that the reference of multi-tasking can be expanded from one robot.

The virtual robot control machine scheduler (VRCM scheduler) 104 is responsible for processing a variety of events occurring from tasks that operate. Events processed by the VRCM scheduler 4 may include a periodic interrupt, an intermittent interrupt, a parallel processing sentence, a specific message wait and a user's request for instruction processing.

An event occurring between tasks, i.e., an event between the robots is implemented through the IVC 109. The IVC 109 is a software module existing in the device driver of the PC. It refers to a kind of a memory region shared by the plurality of virtual robot control machines generated by the VRCM manager 103.

If TASK1 and TASK2 are executed through the IVC 109 at the same time, a necessary task execution order can be managed through semaphore or the implementation of an event. The VRCM scheduler 4 is a module of a soft real-time control machine. This means that it is impossible to guarantee the real-time property that must be included in the robot control machine. The execution of a corresponding module itself is also meaningless.

The present embodiment proposes the operation of the soft real-time VRCM scheduler 104 using the hardware operating reference time control machine 110 of the real-time control machine in order to assign the real-time property to the VRCM scheduler 104 included in the soft real-time control machine. The VRCM scheduler 104 operates according to an operating reference time of the hardware operating reference time control machine 110 of a motion controller (i.e., a real-time region), which is received through the IVC 109.

This configuration means that the soft real-time control machine, i.e., an application program of the soft real-time Os can be made real-time. The software-based robot control machine becomes a major basis that may replace the existing hardware-based robot control machine. It can be seen that the update of the reference time on which the VRCM scheduler 104 operates is received from the real-time control machine.

The VRCM 106 of FIG. 5 executes a user task program written in order to perform a task. The VRCM 106 is a module in which a process in which a dedicated control machine is operated in the hardware-based control system is implemented using software. The VRCM 106 executes the robot language. Furthermore, the VRCM 106 interprets the robot language and transfers an instruction to the real-time control machine.

The IVC 109 of FIG. 5 is a communication module that exchanges messages on a task basis in performing the synchronization task. The IVC 109 is shared by the entire module defined in the present embodiment. Different robot control machines can perform the synchronization task through the IVC 109.

The RUSH 102 is an integrated communication module that supports communications between the PC-based control machine and the external module. The RUSH 102 is responsible for changing an externally received communication protocol into the VRCM 106 protocol. The RUSH 102 has been simply described because it is not related to the multi-tasking task that is described in the present embodiment.

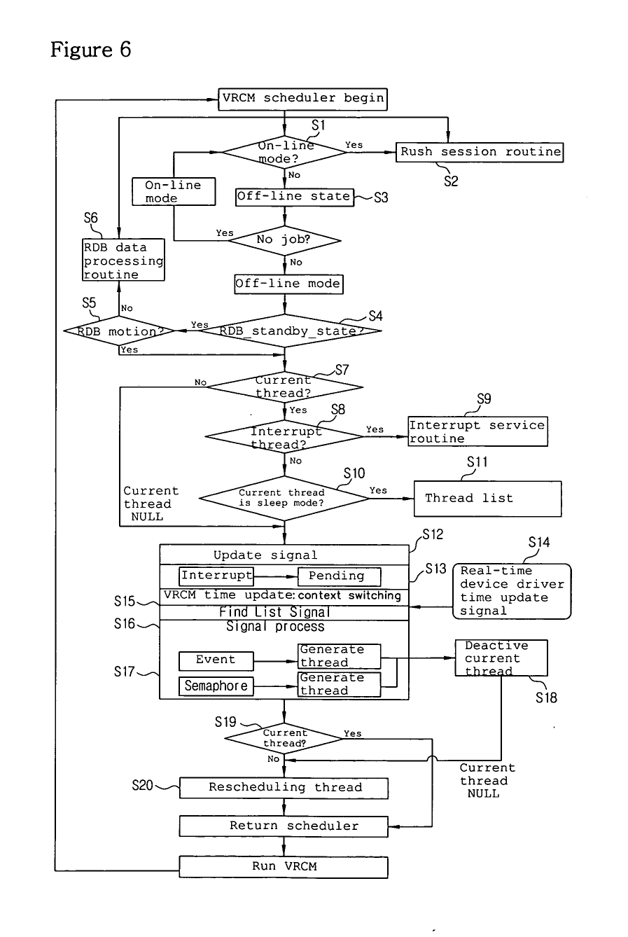

FIG. 6 is a flowchart showing the operation of a virtual robot controller scheduler for illustrating multi-tasking within a virtual robot controller according to an embodiment of the present invention.

In step (S1), it is determined whether mode is on-line mode. This step refers to a state where a task-related robot does not operate according to an operating mode-related instruction of the virtual robot control machine.

Step (S2) corresponds to a module performed by the operation of the step (S1). It corresponds to a module that performs a specific function according to a user's instruction in the case of the on-line module. A pertinent operation performs a robot-related setting task of a user.

Step (S3) corresponds to an operating mode-related instruction of the robot control machine and is an opposite state to that of the step (S1). This means that the robot begins starting a task.

Step (S4) corresponds to a related instruction to determine whether the robot operates. In this step, it is determined whether the robot operates for debugging purpose or performs a task. Step (S5) corresponds to a robot motion-related instruction and indicates a motion that operates in a debug state.

In step (S6), a task for the robot that operates in debug mode is driven by the user. Step (S7) corresponds to an instruction to determine whether there is a task that is now active, of multi-tasking. Step (S8) corresponds to an instruction to determine whether a task that is now active is an interrupt-related task.

Step (S9) corresponds to an interrupt execution routine selected in step (S8). Step (S10) corresponds to an instruction to determine whether the mode should enter the standby mode in a state where a task that is now active has consumed its operating cycle. Step (S11) corresponds to a module that changes the task selected in step (S10) into the standby mode.

Step (S12) corresponds to an instruction to determine whether there are instructions transferred by other virtual robot control machines while the virtual robot control machine is operated. If it is determined that there are instructions transferred by other virtual robot control machines, the instructions are stored in the instruction storage space.

In step (S13), if other interrupts are generated while a current task performs an interrupt-related task, interrupt information generated in the interrupt storage space is stored.

Step (S14) corresponds to a module that receives a temporal reference instruction from the real-time OS for assigning the real-time property to the soft real-time OS. The temporal reference instruction becomes a reference time for task scheduling of the virtual robot control machine.

Step (S15) corresponds to a module that changes the real-time information, which is received from the step (S14), into an operating reference time of the virtual robot control machine.

Step (S16) corresponds to a module that determines whether there is an external instruction to be performed in a task that is now active. If it is determined that there is an instruction to be performed, a current task becomes empty in order to change the current task into a task for performing the stored instruction.

Step (S17) corresponds to a module that performs a related task if there is an instruction selected in step (S16).

Step (S18) corresponds to a module that processes a new task when an instruction that instructs the new task to be performed is input. Step (S19) corresponds to an instruction to determine whether there is any task that is now active for a scheduling task. If there is a task that is now active, the task is allowed to continue to operate.

Step (S20) corresponds to a module that replaces a task, which will be performed next, with a current task in the task storage of the virtual robot control machine scheduler if there is no task that is now active in step (S19).

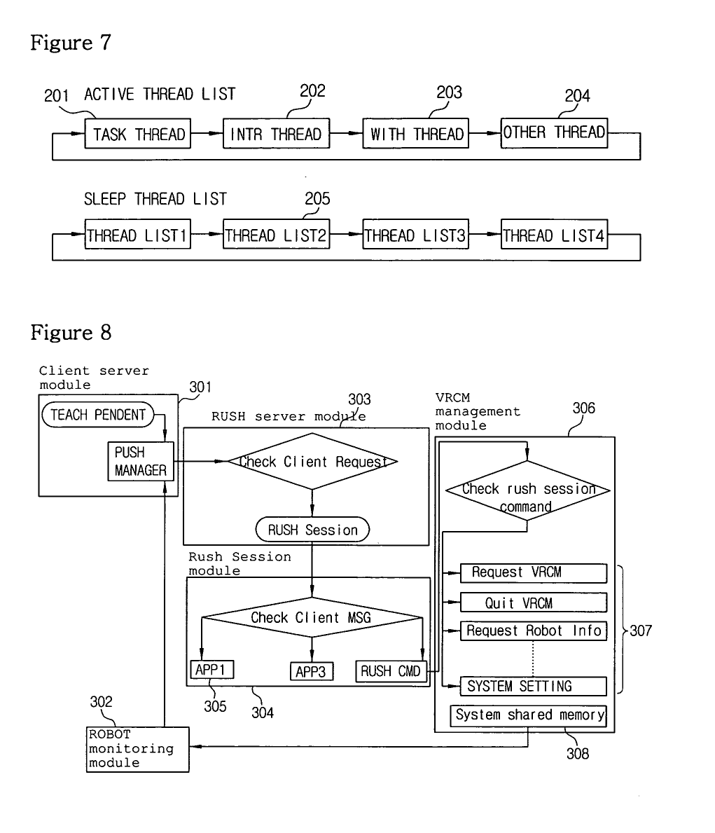

FIG. 7 shows a detailed construction of a storage space for storing a task that should be changed to standby mode and a task that should be performed in FIG. 6.

In FIG. 7, reference numeral “201” designates a space where a task that is now active is stored. If an interrupt has occurred, an interrupt task after the task 201 that is now active is stored and is then performed after 201 is performed.

If a parallel processing situation is generated, a parallel processing task is stored behind a task 1 that is now active and is then performed after 201 is carried out (203). In the event that a new task is generated from a task that is now active, a new task is generated and is stored next to the task that is now active (204). Reference numeral “205” designates a space for storing a task that will enter the standby mode.

FIG. 8 is a flowchart illustrating the transfer flow of instructions on the basis of each communication module while the virtual robot controller is driven.

Referring to FIG. 8, an external module to be used by a user operates separately from the virtual robot control machines that operate as a client server module 301 (i.e., a communication module), which will be used for communication with the virtual robot control machine, and a robot monitoring module 302, which is obtained in a robot state that is now active according to a user's instruction. Therefore, it does not affect the driving of the robot.

A RUSH server module 303 changes an instruction, which is received from a communication server module of a virtual robot control machine, into one that may be used by the virtual robot control machine.

A RUSF session module 304 is an instruction transfer module that selects and performs an instruction which is received from the RUSH server module 303 and is suitable for a user's purpose.

An operating module 305 is a robot-related lower operating module that performs a specific instruction selected by the RUSH session module 304.

A VRCM management module 306 manages the creation and extinction of virtual robot control machines using a virtual robot control machine manager that manages the virtual robot control machines.

An execution module 307 performs a specific operation selected by the management module 306 according to a virtual robot control machine-related instruction. A shared module 308 is a shared storage space that stores all information about the virtual robot control machines for the monitoring task of the robot monitoring module 302.

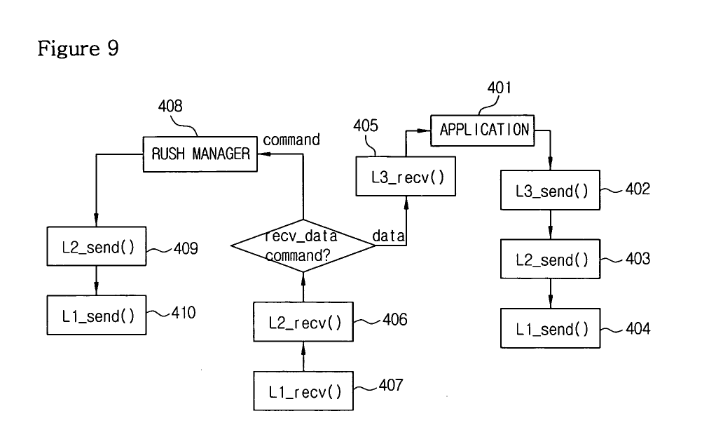

FIG. 9 is a classified flowchart of the communication-related module between the client server module and the RUSH server module of FIG. 8.

Referring to FIG. 9, in step 401, information about a message transferred to a last user application program module is received. In step 402, the same instruction transfer function is used as a user level regardless of communication means (Ethernet, USB, Serial, etc.). This step is a step of implementing the integrated protocol.

In step 403, the message transferred in step 402 is changed into one suitable for communication means. In step 404, the message is transferred through actual communication means. Step 405 corresponds to a message receiving module of the user level in the same manner as 402. In this step, user data of the instruction received from 406 are received.

In step 406, the message received from specific communication means is changed into one suitable for an integrated protocol in the same manner as step 403. In step 407, the message is received through the specific communication means. In step 408, a communication-related instruction of the message received from step 406 is transferred to a server or a client.

In step 409, the instruction received from step 408 is changed into a type of specific communication means. In step 410, the message is transferred to the server or the client through specific communication means.

FIG. 6 is the construction in which the construction of FIG. 5 is reconstructed from the viewpoint of a communication protocol.

The RUSH 102 of FIG. 5 has a three-storied layer construction in order to manage an external communication module provided by a PC. Layer 1 is a layer that manages communication of an actual hardware level and is a module that utilizes resources of the PC itself, such as Ethernet, Serial and USB. Layer 2 is a layer that changes data, which are received from Layer 1, into data structure that can be processed by the VRCM. Layer 3 is a user Application Program Interface (API) layer and is responsible for a transmission/reception instruction.

A user can communicate using the same API regardless of the type of a communication module connected to the PC through the layer configuration. RUSH(2) exists in an external module that will communicate with the PC-based control machine of the present embodiment at the same time.

As in FIG. 8, the RUSH exists in the PC as the concept of a server and a client. The server RUSH 303 transfers a request of a user to the VRCM manager or the VRCM 106 corresponding to a communication request of the client RUSH 301. The RUSH increases convenience by allowing the server and the client to communicate with each other using the same kind of a program through the installation of a simple program without additional manipulation of a user.

As described above in detail, according to the present invention, an existing hardware-based robot control machine type can be applied as a new software-based robot control machine. Furthermore, software-based multi-tasking is made possible. Therefore, a user can construct work environment very effectively in comparison with an existing PC-based control machine type. In addition, since user convenience is enhanced, the productivity can be improved and the production line design cost can be saved.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A software-based robot control system for multi-tasking in which a controller processes a robot control execution sentence written by a user and a robot driving hardware drives a robot,
wherein the controller comprises:
robot system interface means that receives the robot control execution sentence and a virtual robot control command written by the user;
system kernel means that controls the creation and extinction of one or more software-based virtual robot control machines and controls a synchronization task between the virtual robot control machines, based on the virtual robot control command input through the robot system interface means; and
one or more software-based virtual robot control machine means in which the software-based virtual robot control machines are automatically created and become extinct under the control of the system kernel means, wherein a generated virtual robot control machine processes the robot control execution sentence input through the robot system interface means and outputs a robot-driving control signal to the hardware means.

2. The software-based robot control system of claim 1, wherein the robot system interface means comprises:
a communication module (RUSH: Robot User Shell) for receiving the robot control execution sentence and the virtual robot control command written by the user from an user operating apparatus;
a robot user shell protocol that provides a communication protocol of the communication module (RUSH) so that the user (operator) can input the virtual robot control command using the same kind of a command regardless of a communication method between an external apparatus and the communication module; and
a robot debugger (RDB) for performing a debugging task before the user performs a repetitive task of a robot system.

3. The software-based robot control system of claim 1, wherein the software-based virtual robot control machine means comprises:
a Virtual Robot Control Machine (VRCM) execution module that executes a task file for controlling a robot based on the virtual robot control command input through the robot system interface means;
a scheduler for processing multi-tasking of the plurality of software-based virtual robot control machines generated within the software-based virtual robot control machine means; and
a trajectory generation module that generates a trajectory for the operation of the robot based on the execution of the task file by the execution module and outputs the trajectory as a robot control signal.

4. The software-based robot control system of claim 1, wherein the system kernel means comprises:
an internal synchronization module that manages a synchronization task between robots through internal communication between the plurality of software-based virtual robot control machines generated within the software-based virtual robot control machine means;
a system synchronization module that synchronizes an operating time between an OS for a general user and a real-tine OS;
a virtual robot control machine management module that manages the creation and extinction of the software-based virtual robot control machines within the software-based virtual robot control machine means based on the control command input through the robot system interface means;
a shared memory that stores operating programs and data of the robot control system and stores and manages synchronization information about the synchronization modules; and
a hardware device drive module responsible for communication between the robot control system and external hardware.

5. A software-based virtual robot control system for multi-tasking, for implementing a task-based robot control machine function,
wherein the robot control machine comprises a hard real-time control machine and a soft real-time control machine,
the soft real-time control machine comprises:
a communication module responsible for communication with an external module;
a task file management unit that manages a task file written by a user, which has been input through the communication module;
a virtual robot control machine management unit controls the creation and extinction of a plurality of Virtual Robot Control Machines (VRCMs) according to a robot control command of the user, which is received through the communication module; and
the plurality of VRCMs whose creation and extinction are controlled in a software way under the control of the virtual robot control machine management unit, wherein the VRCMs control a robot by executing a task program of the robot based on the task file managed by the task file management unit, and
the hard real-time control machine comprises:
a plurality of trajectory planning units that plan trajectories, respectively, based on control commands of the virtual robot control machines, respectively;
a hardware operating reference time memory that stores a hardware operating reference time so that the trajectory planning units and the virtual robot control machines can perform a synchronization task;
a plurality of motion controllers that generate motion control commands, respectively, in real-time based on the trajectory plans of the trajectory planning units, respectively; and
a DSP controller that controls robot driving hardware by signal-processing the motion control commands of the plurality of motion controllers.
